(19) United States
(12) Patent Application Publication
(10) Pub. No.: US 2022/0313548 A1
(43) Pub. Date: Oct. 6, 2022

(54) SKIN CARE DEVICE

(71) Applicant: VILAIN MARCEL ET FILS, Courcelels (BE)

(72) Inventor: JEAN-NOËL VILAIN, COURCELLES (BE)

(21) Appl. No.: 17/620,157

(22) PCT Filed: Feb. 7, 2020
(86) PCT No.: PCT/EP2020/053093

§ 371 Date: Dec. 20, 2021

(30) Foreign Application Priority Data
Jun. 24, 2019 (EP) PCT/EP2019/066592

(51) Int. Cl. A61H 23/02; A61H 23/00; A61H 7/00

(52) U.S. Cl. CPC A61H 23/0263; A61H 23/006; A61H 7/005; A61H 2201/0153; A61H 2201/0165

(57) ABSTRACT

A vibrating skin care device comprises a handle, an elongate damper, a vibrating drive and a vibrating head with the vibrating head being connected to the vibrating drive via a friction fit, conical connection. The device may be used to exfoliate skin and/or reduce skin blemishes.

In accordance with one of its aspects, the present invention provides a vibrating skin care device comprising:
a handle, an elongate damper, a vibrating drive and a vibrating head;
wherein the skin care device has a longitudinal axis along which each of the handle, the elongate damper, the vibrating drive and the vibrating head are arranged;
wherein the handle and the vibrating drive are connected to each other through the damper;
wherein the handle is connected to the damper via a handle/damper connection;
wherein the vibrating drive comprises a motor which drives a spindle on which an eccentric weight is arranged;
wherein the vibrating drive is connected to the damper via a damper/drive connection;
wherein the damper/drive connection is spaced from the handle/damper connection along the longitudinal axis;
wherein the vibrating drive is connected to the vibrating head by a drive/head connection;
wherein the vibrating head comprises a skin care surface comprising abrasive particles adapted, in use, to be held against a person's skin; and -wherein the drive/head connection is preferably a friction fit conical connection.

In accordance with another aspect, the present invention provides a vibrating skin care device comprising:
a handle, an elongate damper, a vibrating drive and a skin care surface comprising abrasive particles adapted, in use, to be held against a person's skin;
wherein the skin care device has a longitudinal axis along which each of the handle, the elongate damper and the vibrating drive are arranged;
wherein the handle and the vibrating drive are connected to each other through the damper;
wherein the handle is connected to the damper via a handle/damper connection;
wherein the vibrating drive comprises a motor which drives a spindle on which an eccentric weight is arranged;
wherein the vibrating drive is connected to the damper via a damper/drive connection;
wherein the damper/drive connection is spaced from the handle/damper connection along the longitudinal axis; and
wherein the skin care surface is secured to the vibrating drive via a connection which allows manual, tool free detachment and reattachment of the skin care surface to the vibrating drive.

As used herein, the terminology “manual, tool free detachment and reattachment” for example of the skin care surface to the vibrating drive means that the skin care surface may be repeatedly attached to and detached from the vibrating drive by a user by the user using only his or her hands and without the need for any tools, for example without requiring use of a screwdriver or spanner. Such attachment and detachment may serve to swap one skin care surface for another skin care surface, for example to replace a worn skin care surface with a fresh skin care surface or to replace one type of skin care surface with a different type of skin care surface, for example a skin care surface having a different shape and/or granulometry.

The skin care surface may be secured to the vibrating drive via a hook and loop fastening system, for example with the hook portion or the loop portion secured to the vibrating drive or to a drive head which is attached to the vibrating drive and the other portion of the hook and loop fastener being secured to, for example, a rear face of a carrier having the skin care surface provided on a front face. For example, the carrier may comprise a substrate, for example of paper or cardboard, having the skin care surface on a front surface and part of the hook and loop fastener system on a rear surface.

The skin care surface may be secured to a vibrating head with the vibrating head being secured to the vibrating drive via a connection which allows manual, tool free detachment and reattachment of the vibrating head to the vibrating drive. In this latter case, the skin care surface is preferably permanently secured to the vibrating head, for example by an adhesive, for example a ceramic adhesive. Nevertheless, a connection between the skin care surface and the vibrating head which allows manual, tool free detachment and reattachment is possible.

In accordance with a further aspect, the present invention provides a vibrating skin care device comprising:
a handle, an elongate damper and a vibrating drive;
wherein the skin care device has a longitudinal axis along which each of the handle, the elongate damper and the vibrating drive are arranged;
wherein the handle and the vibrating drive are connected to each other through the damper;
wherein the handle is connected to the damper via a handle/damper connection;
wherein the vibrating drive comprises a motor which drives a spindle on which an eccentric weight is arranged;
wherein the vibrating drive is connected to the damper via a damper/drive connection; and
wherein the damper/drive connection is spaced from the handle/damper connection along the longitudinal axis.

Preferably, the vibrating drive is provided with a portion of a drive/head connection via which the vibrating drive is configured to be connected to a vibrating head.

The vibrating head is preferably adapted, in use, to be held against a person's skin. The vibrating head may comprise a skin care surface adapted, in use, to be held against a person's skin; the skin care surface may comprise abrasive particles.

The drive/head connection is preferably a tapered connection, more preferably a friction fit conical connection. Thus, the vibrating drive is preferably provided with a portion of a tapered connection, more preferably a portion of a friction fit conical connection, adapted to cooperate with a corresponding portion of a connection provided on a vibrating head.

Additional aspects of the invention are defined in the independent claims. The dependent claims define preferred and/or alternative embodiments.

Separation of the vibrating head from the handle by the damper increases comfort for the user by reducing the vibration of the handle and avoids gripping of the handle undesirably affecting the vibrational movement of the vibrating drive. The damper may be provided in an elastomeric material, for example a rubber or plastics material; it may have a shore hardness which is ≥45 or ≥50 and/or ≤75, ≤70 or ≤65, for example a shore hardness in the range 50 to 60. Preferably, the damper is secured to the handle and to the vibrating drive by a gripping or clamping arrangement, more preferably between plates or flanges. Such contact may be arranged around the entire or substantially the entire periphery of the damper; this helps to maximise the contact with the damper. Arranging the damper to be of substantially cylindrical cross section may facilitate mounting and/or its contact or connection with the handle and with the vibrating drive. It is preferred for no adhesive to be used in the damper mounting as this facilitates assembly.

Preferably, the vibrating head comprises an abrasive skin care surface adapted, in use, to be held against a person's skin. The abrasive skin care surface preferably comprises abrasive particles, notably mineral particles. The particles may have a Mohs hardness of at least 7, preferably at least 8 and more preferably at least 9. Particles which comprise at least 90 wt % aluminium oxide are preferred; these have been shown effective in the skin care of the present invention. The particles may comprise corundum; white corundum is particularly preferred.

The abrasive particles may have a size distribution such that at least 60% of the particles by mass, preferably at least 80% of the particles by mass, more preferably at least 90% of the particles by mass have a diameter which is 150 μm and 280 μm, notably 180 μm and 250 μm. Such particles provide a relatively course abrasion which is particularly suitable for point contact or small surface contact with the skin, for example for removing hard skin or small skin blemishes. Such contact and/or granulometry may be used with a pointed or significantly convex skin care surface, for example a convex skin care surface having a radius of curvature which is ≤20 mm, ≤15 mm, ≤10 mm or ≤5 mm. This may be provided, for example by a hemi-spherical skin care surface.

Alternatively, the abrasive particles may have a size distribution such that at least 60% of the particles by mass, preferably at least 80% of the particles by mass, more preferably at least 90% of the particles by mass have a diameter which is ≥30 μm and ≤90 μm, notably ≥45 μm and ≤75 μm. Such particles provide a relatively fine abrasion which is particularly suitable for a larger surface contact with the skin, for example to provide gentle exfoliation and/or tightening of the skin. Such contact and/or granulometry may be used with a planar or slightly convex skin care surface, for example a convex skin care surface having a radius of curvature which is ≥30 mm, ≥40 mm or ≥50 mm.

The size distribution of the abrasive particles is preferably determined by sieving.

Arranging the skin care surface as an insert provided on the vibrating head facilitates a user's ability to switch between a plurality of skin care surfaces by simply changing the vibrating head of the device.

The tapered connection is preferably a conical connection; it is preferably self-holding or self-locking; it is preferably the only means provided for retaining the vibrating drive and the vibrating head together. A self-holding or self-locking taper connection is particularly advantageous as it alleviates the tendency of other forms of connection (for example cylindrical screws or clips) to vibrate and/or work themselves loose. Furthermore, such a connection helps to ensure that the available vibrational energy is transmitted through the connection without loss of vibrational energy in or due to the mechanical fixing. The connection between the vibrating drive and the vibrating head is preferably provided by an interaction between surfaces as opposed to a point contact or series of point contacts. This provides stability and rigidity to the connection. A cone form of connection is particularly preferred as this facilitates mounting and dismounting of the vibrating head, for example using a slight rotation. It also permits the user to select the orientation of the vibrating head with respect to the vibrating drive. The connection between the vibrating drive and the vibrating head is preferably a cone-in-cone connection. A morse cone may provide a particularly convenient form. Preferably, the vibrating drive is provided with a tapered connection in the form of a trunnion. A connector having the form of a bore may be at greater risk of damage than a connector having the form of a trunion, especially in respect of the lip of the bore when made of a plastics material. Thus, the vibrating drive when provided with a tapered connection in the form of a trunnion may reduce the risk of damage to the vibrating drive; a damaged vibrating head may be more easily replaced than a damaged vibrating drive, especially as the vibrating drive incorporates a vibrating mechanism. The taper length may be ≥6 mm or ≥8 mm and/or ≤30 mm or ≤20 mm; the taper angle may be within the ranges 0.5° to 12.5°, 1° to 25°, 1° to 2° or 2 to 4°. Such configuration may facilitate assembly and/or disassembly and/or self-locking of the connectors.

A vibration movement which comprises a translation, possibly as part of a rotational movement, has been found to provide an effective vibration action for the skin care device. The amplitude in translation measured at the skin care surface is preferably in the range 0.2 mm to 2 mm, more preferably 0.2 mm to 1 mm; this has likewise been found to provide an effective vibration action for the skin care device. The direction or rotation of the motor may be selectable by the user, for example via a switch.

The handle preferably comprises a front projection which projects along the longitudinal axis beyond the handle/damper connection to at least partially enclose the vibrating drive. Preferably, the front projection encircles the entire periphery of the vibrating drive along at least part of the longitudinal length of the vibrating drive. This allows at least a portion of the vibrating drive to be housed within a periphery provided by the handle. This also provides a portion of the handle which can be gripped by a user and which is closer to the skin care surface along the longitudinal axis than the handle/damper connection. This can be useful for ease and precision of handling of the device.

Preferably, the longitudinal axis of the skin care device is curved when considering a cross sectional view of the device. This facilitates its ergonomics and precision of use.

Each of the handle, vibrating drive and vibrating head may comprise an assembly comprising one or more moulded plastics parts.

The skin care device has been found effective in each of the following and thus, in accordance with a further aspect, the present invention provides for use of the skin care device of the present invention for one or more of:
exfoliation of the skin, notably by microdermabrasion;
promoting tightening of the skin;
cosmetically treating skin, for example the skin on a person's face and/or neck;
reduce or removing rough skin, notable calluses or corns, for example on a person's hands or feet;
reducing skin blemishes, notably liver spots.

An embodiment of the invention will now be described, by way of example only, with reference to the accompanying drawing of which:

FIG. 1 is an exploded perspective view of a skin care device;

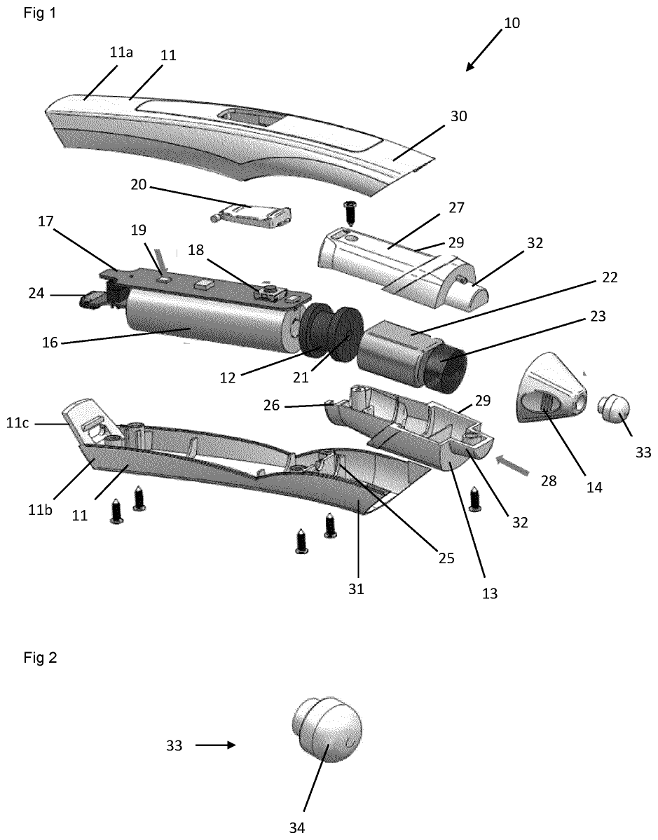

FIG. 2 is a perspective view of an abrasive insert;

FIG. 3 is a top view of the skin care device;

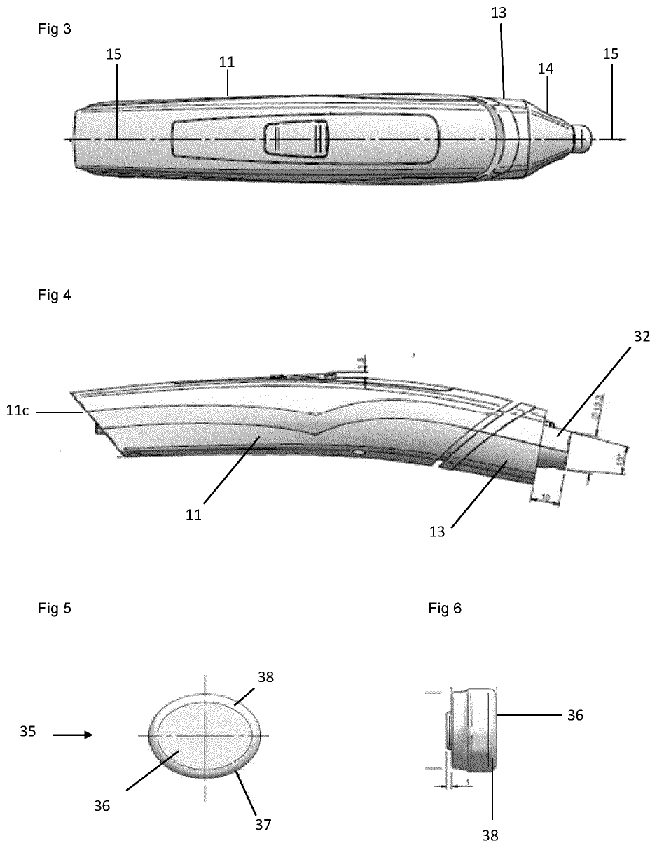

FIG. 4 is a side view of the skin care device;

FIG. 5 is front view of an alternative abrasive insert; and

FIG. 6 is side view of the abrasive insert of FIG. 5.

The vibrating skin care device 10 shown in FIGS. 1, 3 and 4 comprises a handle 11, an elongate damper 12, a vibrating drive 13 and a vibrating head 14, each arranged along a longitudinal axis 15 of the device 10.

The handle 11 comprises an upper handle housing 11a and a lower handle housing 11b which house a battery 16, a circuit board 17, an on-off switch 18 and an LED indicator 19. The on-off switch 18 is actionable by a user via a user switch 20 which projects through an opening in the upper housing handle 11a. Electrical wires (not shown) pass through a central, damper orifice 21 from the battery 16 to a motor 22 of the vibrating drive 13 to cause the motor 22 to rotate its spindle to which an eccentric mass 23 is attached. This rotation, controlled by the on-off switch 18 and circuit board 17, causes the vibrating drive 13 to vibrate. Preferably the battery 16 is rechargeable; in this case, a connection for recharging the battery, for example a USB connection 24, is provided, for example in a rear face 11c of the handle. Preferably, the device is configured, for example by means of the on/off switch 18 and/or the circuit board 17, to allow the user to select between vibrational frequencies, for example, between a maximum vibrational frequency, 80% of the maximum vibrational frequency and 75% of the maximum vibrational frequency.

The handle 11 is clamped to one end of the elongate damper 12 by a handle/damper clamp of which a lower portion 25 is provided as part of the lower handle housing 11b and an upper portion (not shown) is provided as part of the upper handle housing 11a. The vibrating drive 13 is clamped to the other end of the elongate damper 12 by a drive/damper clamp 26 provided by assembly of upper 27 and lower 28 portions of a drive housing 29. The motor 22 is clamped within the drive housing 29 so that rotation of the motor 22 and its eccentric mass 23 cause vibration of the vibrating drive 13. Upper 30 and lower 31 front projections of the handle 11 project over the damper 12 and over a rear portion of the vibrating drive 13 with sufficient clearance being provided to allow the vibrating drive to vibrate within the space defined by the front handle projections 30, 31 without contacting the front handle projections 30, 31.

A front portion of the vibrating drive 13 is provided with a conical drive/head connection 32. This allows connection of the vibrating head 14 to the vibrating drive 13 via a cooperating tapered connection (not shown) of the vibrating head 14.

The vibrating head 14 comprises an abrasive insert 33. The abrasive insert is preferably permanently fixed to the vibrating head 14, for example using an adhesive, for example an enamel adhesive.

As shown in FIG. 2, the abrasive insert 33 of FIG. 1 has a substantially hemi-spherical skin care surface 34 which, when the device is vibrating and in use, is held against a person's skin, for example to remove rough skin and/or exfoliate the skin. This abrasive insert is made of relatively large particles of corundum, for example having a particle size between 180 μm and 250 μm.

The handle 11 and the vibrating drive 13 are connected to each other through the damper 12 with the damper/drive connection 26 being spaced from the handle/damper connection 25 along the longitudinal axis 12.

As can be seen in FIG. 4, in this embodiment, the axis 15 of the skin care device 10 has a gentle curve when seen in a side view. This is a preferred arrangement which contributes to comfort and precision when holding and using the device. FIG. 4 shows the devise without the vibrating head 14 to illustrate the drive/head connection 32.

An alternative abrasive insert 35 is shown in FIGS. 5 and 6. This has a substantially planar skin care surface 36. The periphery 37 of this abrasive insert 24 is elliptical; alternatively, the periphery may be circular. A chamfered edge 38 is provided between the skin care surface 36 and the periphery. This abrasive insert is made of relatively small particles of corundum, for example having a particle size between 45 μm and 75 μm.

Reference numbers used in the figures:
10 skin care device
11 handle
11a upper handle housing
11b lower handle housing
11c rear face of handle
12 damper
13 vibrating drive
14 vibrating head
15 longitudinal axis
16 battery
17 circuit board
18 on-off switch;
19 LED indicator
20 user switch
21 central damper orifice
22 motor
23 eccentric mass
24 USB connector
25 handle/damper clamp
26 drive/damper clamp
27 upper portion of drive housing
28 lower portion of drive housing
29 drive housing
30 upper front projection of the handle
31 lower front projection of the handle
32 drive/head connection
33 abrasive insert
34 hemi-spherical skin care surface
35 alternative abrasive insert
36 planar skin care surface
37 periphery of abrasive insert
38 chamfered edge

1-14. canceled

15. A vibrating skin care device comprising:
a handle, an elongate damper, a vibrating drive and a vibrating head;
wherein the skin care device has a longitudinal axis along which each of the handle, the elongate damper, the vibrating drive and the vibrating head are arranged;
wherein the handle and the vibrating drive are connected to each other through the damper;
wherein the handle is connected to the damper via a handle/damper connection;
wherein the vibrating drive comprises a motor which drives a spindle on which an eccentric weight is arranged;
wherein the vibrating drive is connected to the damper via a damper/drive connection;
wherein the damper/drive connection is spaced from the handle/damper connection along the longitudinal axis;
wherein the vibrating drive is connected to the vibrating head by a drive/head connection;
wherein the vibrating head comprises a skin care surface comprising abrasive particles adapted, in use, to be held against a person's skin; and
wherein the drive/head connection is a tapered connection.

16. The vibrating skin care device of claim 15,
wherein the drive/head connection is a friction fit conical connection.

17. The vibrating skin care device of claim 15,
wherein the skin care surface is provided by a mass of moulded abrasive particles held together by an organic resin.

18. The vibrating skin care device of claim 17,
wherein the skin care surface is provided on an abrasive insert, the abrasive insert being secured to a vibrating head housing, and the vibrating head housing having a conical connection portion which cooperates with a conical connection portion of the head connector of the vibrating drive to releasably connect the vibrating drive and the vibrating head to each other.

19. The vibrating skin care device of claim 15,
wherein the skin care device is provided with a plurality of vibrating heads having abrasive inserts which are different from each other, each of which has an abrasive skin care surface selected from an abrasive skin care surface having a different shape, an abrasive skin care surface having a different distributions of particle sizes, and combinations thereof.

20. The vibrating skin care device of claim 15,
wherein the skin care surface is selected from:
a) a skin care surface which comprises abrasive particles having a size distribution such that at least 60% of the particles by mass have a diameter which is ≥150 μm and ≤280 μm;
b) a skin care surface which comprises abrasive particles having a size distribution such that at least 80% of the particles by mass have a diameter which 180 μm and 250 μm;
c) a skin care surface which comprises abrasive particles having a size distribution such that at least 80% of the particles by mass have a diameter which 180 μm and 250 μm and wherein the skin care surface is substantially hemi-spherical;
d) a skin care surface which comprises abrasive particles having a size distribution such that at least 60% of the particles by mass have a diameter which is ≥30 μm and ≤90 μm;
e) a skin care surface which comprises abrasive particles having a size distribution such that at least 80% of the particles by mass have a diameter which is ≥45 μm and ≤75 μm;
f) a skin care surface which comprises abrasive particles having a size distribution such that at least 80% of the particles by mass have a diameter which is 45 μm and 75 μm and wherein the skin care surface is substantially planar.

21. The vibrating skin care device of claim 15,
wherein, in use, the skin care surface vibrates at a frequency which is selected from:
a) a frequency which is ≥50 Hz and ≤100 Hz; and
b) a frequency which is ≥60 Hz and ≤85 Hz.

22. The vibrating skin care device of claim 15,
wherein,
the motor is adapted to rotate at a speed within the range 8000 to 12000 rpm when unloaded; and
the eccentric weight has a mass in the range 5 to 7 g and is arranged with an eccentricity with respect to the axis of the motor within the range 1 to 4 mm.

23. The vibrating skin care device of claim 15,
wherein the skin care surface is secured to the vibrating drive via a connection which allows manual, tool free detachment and reattachment of the skin care surface to the vibrating drive.

24. A method of cosmetically treating skin comprising contacting the skin the vibrating skin care surface of the vibrating skin care device of claim 15.

25. The method of claim 24, wherein the method exfoliates the skin by microdermabrasion.

26. The method of claim 24, wherein the method reduces skin blemishes.

27. A vibrating skin care device comprising:
a handle, an elongate damper, a vibrating drive and a skin care surface comprising abrasive particles adapted, in use, to be held against a person's skin;
wherein the skin care device has a longitudinal axis along which each of the handle, the elongate damper and the vibrating drive are arranged;
wherein the handle and the vibrating drive are connected to each other through the damper;
wherein the handle is connected to the damper via a handle/damper connection;
wherein the vibrating drive comprises a motor which drives a spindle on which an eccentric weight is arranged;
wherein the vibrating drive is connected to the damper via a damper/drive connection;
wherein the damper/drive connection is spaced from the handle/damper connection along the longitudinal axis; and
wherein the skin care surface is secured to the vibrating drive via a connection which allows manual, tool free detachment and reattachment of the skin care surface to the vibrating drive.

28. The vibrating skin care device of claim 27,
wherein the drive/head connection is a friction fit conical connection.

29. The vibrating skin care device of claim 27,
wherein the skin care surface is provided by a mass of moulded abrasive particles held together by an organic resin.

30. The vibrating skin care device of claim 29,
wherein the skin care surface is provided on an abrasive insert, the abrasive insert being secured to a vibrating head housing, and the vibrating head housing having a conical connection portion which cooperates with a conical connection portion of the head connector of the vibrating drive to releasably connect the vibrating drive and the vibrating head to each other.

31. The vibrating skin care device of claim 27,
wherein the skin care device is provided with a plurality of vibrating heads having abrasive inserts which are different from each other, each of which has an abrasive skin care surface selected from an abrasive skin care surface having a different shape, an abrasive skin care surface having a different distributions of particle sizes, and combinations thereof.

32. The vibrating skin care device of claim 27,
wherein the skin care surface is selected from :
a) a skin care surface which comprises abrasive particles having a size distribution such that at least 60% of the particles by mass have a diameter which is ≥150 μm and ≤280 μm;,
b) a skin care surface which comprises abrasive particles having a size distribution such that at least 80% of the particles by mass have a diameter which ≥180 μm and ≤250 μm;
c) a skin care surface which comprises abrasive particles having a size distribution such that at least 80% of the particles by mass have a diameter which ≥180 μm and ≤250 μm and wherein the skin care surface is substantially hemi-spherical;
d) a skin care surface which comprises abrasive particles having a size distribution such that at least 60% of the particles by mass have a diameter which is ≥30 μm and ≤90 μm;
e) a skin care surface which comprises abrasive particles having a size distribution such that at least 80% of the particles by mass have a diameter which is ≥45 μm and ≤75 μm;
f) a skin care surface which comprises abrasive particles having a size distribution such that at least 80% of the particles by mass have a diameter which is ≥45 μm and ≤75 μm and wherein the skin care surface is substantially planar.

33. The vibrating skin care device of claim 27,
wherein, in use, the skin care surface vibrates at a frequency which is selected from:
a) a frequency which is ≥50 Hz and ≤100 Hz; and
b) a frequency which is ≥60 Hz and ≤85 Hz.

34. The vibrating skin care device of claim 27,
wherein,
the motor is adapted to rotate at a speed within the range 8000 to 12000 rpm when unloaded; and
the eccentric weight has a mass in the range 5 to 7 g and is arranged with an eccentricity with respect to the axis of the motor within the range 1 to 4 mm.
